(19) United States
(12) Patent Application Publication
(10) Pub. No.: US 2025/0322186 A1
(43) Pub. Date: Oct. 16, 2025

(54) SYSTEMS AND METHODS FOR TRACKING OBJECT LOCATIONS

(71) Applicant: Federal Express Corporation, Memphis, TN (US)

(72) Inventors: Trenton FOX, Harrison, AR (US); Cameron PASCHKE, Harrison, AR (US)

(21) Appl. No.: 18/633,218

(22) Filed: Apr. 11, 2024

(51) Int. Cl. G06K 7/10; H04W 4/029

(52) U.S. Cl. CPC G06K 7/10475; H04W 4/029

(57) ABSTRACT

Methods and System for tracking an object including steps of receiving a stream of signals of an object from a plurality of tag readers, each signal within the stream of signals comprises a first raw location, a second raw location, and a timestamp, determining a first motion status of the object using the first raw location, assigning the object to a first process or a second process based on the first motion status, in response to the assignment to the first process, calculating a first or second location using the corresponding raw locations in a corresponding process, publishing the calculated location as a true location, and associating the true location to the object.

### TECHNICAL FIELD

The present disclosure relates to the field of wireless object location tracking. In particular, some embodiments of the present disclosure relate to inventive and unconventional systems and methods for tracking the location of objects in environments such as warehouses.

### BACKGROUND

Wireless tracking technologies, such as Radio Frequency Identification (RFID), are integral to modern inventory management systems such as warehouses. In these systems, objects are typically tagged with wireless transmitters, which are then read by tag readers to determine the object's locations.

RFID technology has been widely adopted for tracking the locations of objects in various settings, including warehouse environments. In a typical RFID setup, objects are tagged with RFID tags, which are read by multiple RFID readers or antennas to determine the location of the objects. This system provides significant advantages over traditional inventory and asset tracking methods.

Current wireless tracking systems, including RFID-based ones, often suffer from location accuracy issues. For example, tolerances in the readings can make stationary objects appear to move randomly, leading to misleading data and inefficient decision-making. While some RFID-based tag readers may calculate an average location to report, such location averaging is typically calculated over a short amount of time before reporting to downstream systems and has insufficient time span to account for the same tag being read by multiple readers at the same time. These issues are exacerbated when tracking moving objects. For example, location inaccuracies can result in errors in determining parameters such as movement speed and direction, affecting operational efficiency.

Challenges also arise when objects move between the coverage areas of different receivers or antennas. This can lead to discrepancies in readings and the creation of blind zones where objects are temporarily “lost” from the system. Such limitations hinder continuous and accurate tracking of objects within the system.

### SUMMARY

One aspect of the present disclosure is directed to a system for tracking objects, comprising at least one processor and at least one non-transitory memory storing instructions, when executed by the at least one processor, perform the steps of receiving a stream of signals of an object from a plurality of tag readers, the stream of signals comprises a plurality of signals in chronological order, each of the stream of signals comprises a first raw location, a second raw location, and a timestamp, determining a first motion status of the object using the first raw location, assigning the object to a first process or a second process based on the first motion status, in response to the assignment to the first or second process, calculating a corresponding first or second location using the corresponding first or second raw locations in a corresponding first or second process, and publishing the corresponding first or second location as a true location, and associating the true location to the object.

### BRIEF DESCRIPTION OF THE DRAWINGS

FIG. 1 is an illustration of a warehouse, consistent with embodiments of this disclosure.

FIG. 2 is a schematic block diagram illustrating an embodiment of a system for tracking object locations, consistent with embodiments of this disclosure.

FIG. 3 is a schematic block diagram illustrating an embodiment of a method for tracking object locations, consistent with embodiments of this disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for wirelessly tracking locations of objects, especially tracking freights in a warehouse setting.

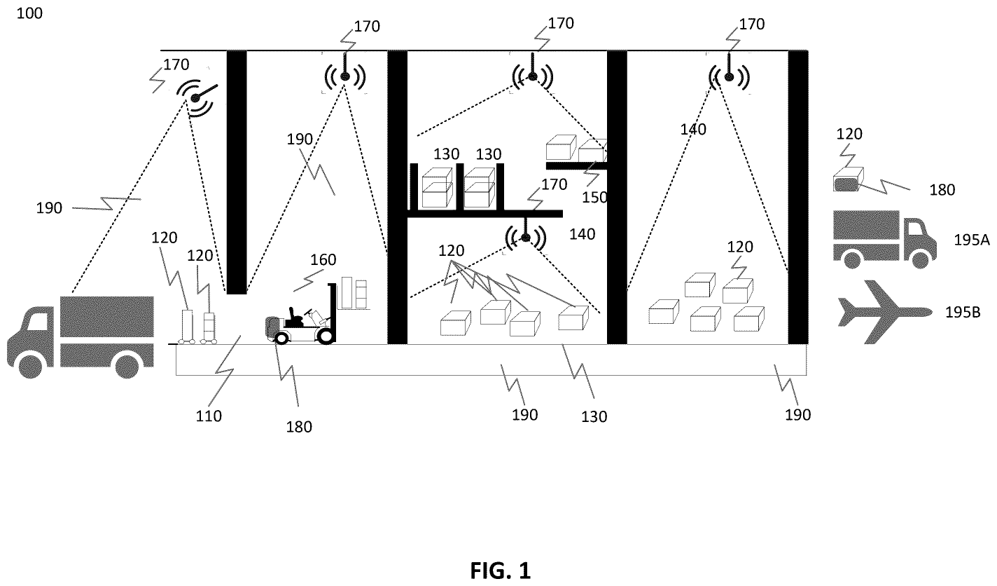

FIG. 1 is an illustration of a warehouse 100, consistent with embodiments of this disclosure. A warehouse is a space or facility designed for storage of goods, materials, merchandise, and other items. It serves as a central point in the supply chain where products or freights are temporarily held before they are shipped to retailers, wholesalers, or directly to customers. While using a warehouse as an example, the disclosed systems and methods may be applicable in different environment settings where freight is stored, organized, reorganized, loaded, and unloaded.

In some embodiments, the warehouse 100 may have at least one door 110 for receiving and putting away freight 120. In some embodiments, the warehouse 100 may have separate doors 110 for receiving freight 120 and putting away freight 120. In some embodiments, the warehouse 100 may have multiple areas. The multiple areas may be divided or subdivided based on function or location. For example, the warehouse 100 may have a loading/unloading area, corridor, storage area, transitioning area, etc. A storage area may be further subdivided into multiple numbered sub-area, or may be further subdivided into sub-areas for different type of freight, e.g., pallet area, machinery area, refrigerated area, area with environmental control (e.g., temperature and/or humidity control), etc.

In some embodiments, the warehouse 100 may have a plurality of storage bays 130. Each of the plurality of storage bays 130 may have at least one level 140. In other words, each storage bays 130 may be able to keep freight 120 stacked. In some embodiments, multiple pieces of freight 120 may be stacked in a same storage bay 130 on different shelves 150. In some embodiments, multiple pieces of freight 120 may stack on each other without shelves 150, for example, one freight 120 may stack on another freight 120 directly with their pallets on.

In some embodiments, freight 120 may refer to goods and cargo that are being stored, handled, and transported in, to, or from the warehouse 100. In some embodiments, freight 120 may be palletized goods, loose cartons or boxes, bulk goods, barrels, drums, crates, rolls, coils, caged goods, or the like. In some embodiments, freight 120 may be a machinery, cars, trucks, or other vehicles or heavy machines. In this disclosure, freight 120 may be generally referred to as “objects” being tracked.

In some embodiments, the warehouse 100 may have a plurality of carriers 160 operating in the warehouse 100. A carrier 160 is a moving vehicle with the capability to carry multiple pieces of freight with it. For example, a carrier 160 may be a forklift, a pallet jack (i.e., hand trucks,) an automated guided vehicle (AGV), a tow tractor, a tugger, a reach truck, a cart (i.e., push cart, a shelving cart,) a dolly, a scissor lift, a crane system (e.g., a bridge crane or a gantry crane,) a tilt truck, or a robotic transporting system.

In some embodiments, the warehouse 100 may have its space divided into zones. Each of the zones may be identified by a set of coordinates. In some embodiments, the freight 120 may be organized next to each other on the floor of the warehouse 100 so no shelves 150 is needed. In such case, a top view of the warehouse floor (i.e., a floor plan or floor map) may be sufficient to display and monitor the locations of freight 120 and carrier 160.

In some embodiments, the warehouse 100 may have a plurality of tag readers 170 installed in or near the warehouse 100. Tag readers may be antennas, sensors, or any signal receivers that may actively or passively obtain or receive information stored in a tag. In some embodiments, the installation locations of tag readers 170 may align with the zones of the warehouse.

In some embodiments, a tag 180 may be a device or object that contains information and is equipped with a unique identifier. The unique identifier may distinguish itself from other tags 180 in the system. In some embodiments, a tag 180 may have a memory component that stores data, which may include information such as the unique identifier (e.g., an identification number) and other relevant information associated with the tag 180. In some embodiments, the tag 180 may be a passive tag, i.e., the tag does not have an internal power source and rely on the energy provided by the tag reader 170 during communication with the tag reader 170. In some embodiments, the tag 180 may be an active tag, i.e., the tag has its own power source (e.g., battery) to actively transmit data to the tag reader 170. An active tag can generally operate at greater distances than passive tags. Some tag brands, for example, include Avery Dennison/Smartrack, Beontag/Confidex, Nam Viet, Checkpoint, Omni-ID, etc.

In some embodiments, the tags 180 in the disclosed system may be passive or active, or a combination of passive tags and active tags. In some embodiments, the tags 180 may be sticker tags, inlay/insert tags, or hard tags installed to carriers 160 and draw power from them. In some embodiments, the system may track tags 180 on freight 120 and on carriers 160 similarly.

In some embodiments, the plurality of tag readers 170 may be positioned on an elevated location above the warehouse floor, for example, on or near the inside of warehouse ceiling, on columns, beams, or walls of the warehouse, on a standalone post or pole, or on suspended wires above the floor.

In some embodiments, the tag readers 170 may receive signals (e.g., read a tag wirelessly) within a certain angle. Because the tag reader 170 is positioned above the floor, when unobstructed (e.g., by shelves, bays, walls, columns, pipes and other utilities in the warehouse), the tag reader 170 may cover a conical area 190, with the tag reader 170 being at the vertex of a conical area 190. In some embodiments, the angle may be larger than 180 degrees, and even a full 360 degrees. Therefore, the conical area becomes a spherical frustum (i.e., a sphere with the tag reader at the center minus a spherical cap created by the warehouse floor.) In case the angle is larger than 180 degrees but less than 360 degrees, the area 190 below the tag reader is the same as the area 190 in case the angle is a full 360 degrees. In some embodiments, the conical area 190 or the spherical frustum area may be incomplete due to structures of the warehouse (e.g., columns, beams, walls, shelves) blocking some area off. In this disclosure, the area covered by a tag reader 170 may be referred to as a conical area 190, even if it may be a spherical frustrum and/or being incomplete due to other structures' blocking.

In some embodiments, because of the arrangements of the tag readers 170 in the warehouse and/or the conical area 190 being incomplete, the conical areas 190 from adjacent tag readers 170 may overlap or leave a gap that is not covered. Because each tag reader 170 covers a conical area 190, which projects at different height a circle of different size, the overlapping areas and gaps may vary at different elevations.

In some embodiments, the tag reader 170 may include a non-transitory memory to store algorithms, preset rules, and instructions. In some embodiments, the tag reader 170 may include a transitory memory to store temporary data.

In some embodiments, each of the multiple pieces of freight 120 and carriers 160 may have a tag 180 attached or affixed to it, and thus associated with the tag 180 through the tag's unique identifier. In some embodiments, the associations between the freight 120 or carrier 160 and the corresponding tag's unique identifier may be stored on one or more database in the one or more non-transitory memory.

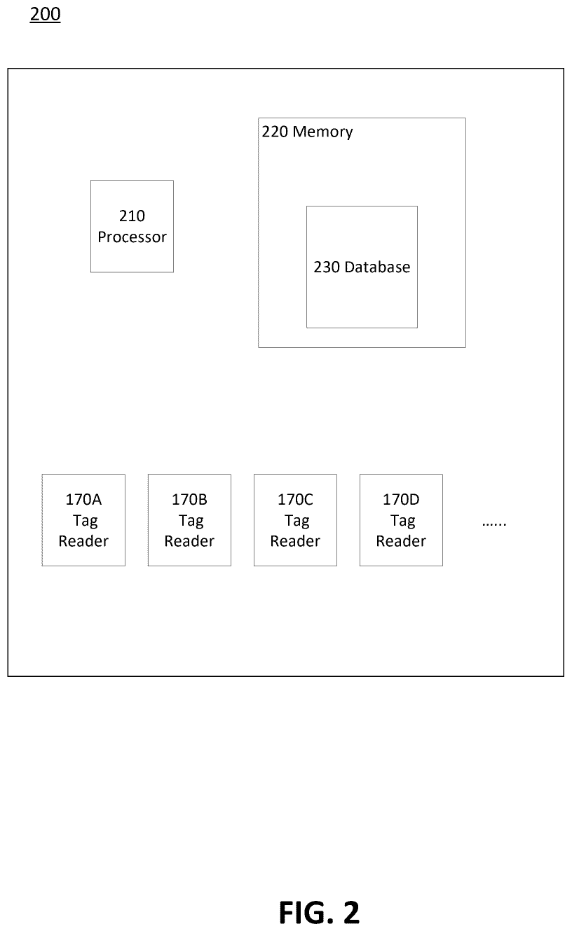

FIG. 2 is a schematic block diagram illustrating an embodiment of a wireless system 200 for tracking object locations, consistent with embodiments of this disclosure. In some embodiments, the system 200 may include at least one processor 210 and at least one non-transitory memory 220 storing instructions, which when executed perform methods for tracking object locations, as described in various embodiments of this disclosure. In some embodiments, the system 200 may also include at least one transitory memory 225 to store temporary information, for example, calculated locations within a preset length of time. In this disclosure, the at least one processor 210 refers to processors in general, and may be processors in a server, a desktop computer, and/or a mobile device (e.g., laptop, smartphone).

The at least one non-transitory memory 220 may refer to non-transitory memory, which retains data even when power is turned off or the system is shut down; the at least one transitory memory 225 may refer to transitory memory, which retains data only while power is supplied to it and loses the data stored in it when the power is turned off. In some embodiments, the non-transitory memory 220 may be hard disk drives (HDDs), Solid-State Drives (SSDs), or flash memory in local or remote servers, or on cloud servers. In some embodiments, the at least one non-transitory memory 220 may be multiple memories on different servers, each memory 220 may perform one or more functions similar or different from other memories 220. In some embodiments, the at least one transitory memory is used to store short-term data, for example, calculated locations within the processing windows. In some embodiments, the at least one transitory memory 225 may be Random Access Memory (RAM) or cache memory. In this disclosure, when not specifically distinguished, memory 220 may refer to non-transitory memory 220 or transitory memory 225. In some embodiments, the system 200 may include at least one database 230 stored on memory 220. In some embodiments, the database 230 may store information about the warehouse 100, the multiple pieces of freight 120 being tracked, the carriers 160 used to move the multiple pieces of freight 120. In some embodiments, the database 230 may include algorithms (e.g., calculation processes, different element weights in averaging calculations, or any other rules and procedures in executing the disclosed methods.)

In some embodiments, the warehouse 100 may have a coordinate system established to describe locations. In some embodiments, the coordinate system may be a 2-dimensional system. In some embodiments, the coordinate system may be a 3-dimensional system. In some embodiments, the coordinate system may be a Cartesian coordinate system with two coordinates (i.e., x-coordinate and y-coordinate) representing the horizontal position on the floor plane and a third coordinate (z-coordinate) representing the vertical position, i.e., height. In some embodiments, other coordinate systems may be adopted.

In some embodiments, the location may also include one or more orientations or directions. For example, a location of a carrier 160 may include, not only its position in the coordinate system, but also the direction it is facing (e.g., the direction the fork of a forklift is pointing to.) For another instance, the location of a carrier 160 may also include its moving direction, which is the direction it is moving towards, and may or may not be the same as the direction a carrier is orienting at.

While a carrier 160 typically moves on the floor level, in some embodiments, a z-coordinate of the location may indicate the operating height of the carrier 160. For example, a forklift may move on the warehouse floor, where only x- and y-coordinates are needed for locating the forklift, and its z-coordinate may indicate the height of the fork blades. In other words, the location in the tag read may indicate that the forklift is operating (e.g., loading or unloading objects) at this height. In some embodiments, the tolerances may be dictated by the tag reader specification and use environment (e.g., temperature, humidity, or any other environmental conditions that may impact the data transmission between the tag and the tag reader).

In some embodiments, the z-coordinate of the location may be corrected by the referencing the operating status of the carrier 160. For example, the processor may consider a separate communication with the forklift reporting its fork blade operating height, and use this information to correct z-coordinate of a corresponding tag read at the same moment.

In some embodiments, information about the warehouse 100 may include the warehouse dimensions, floor plans, ceiling heights, door locations (e.g., dock doors, emergency exits,) tag reader specifications and installation locations, racking and storage system locations and types, climate control (e.g., temperature and humidity control and maps,) security measures (e.g., access control, surveillance locations and capabilities.) In some embodiments, the locations and dimensions may be at least in part using the coordinate system. For example, the information about a door 110 may include its size, location, and open direction, which may be described at least in part through its coordinates (e.g., at least one coordinate for a key point of the door, and/or length of the door, its swinging direction and sweeping area.) In some embodiments, this information may be stored in the at least one memory 220 as coordinate pairs or a set of coordinates. In some embodiments, the processors 210 may consider multiple pieces of freight 120 in the warehouse 100 generally as objects being tracked. Because each freight 120 or carrier 160 has a corresponding tag 180, which has a unique identification, any processor 210 may associate the freight 120 or carrier 160 and its corresponding tag 180 or tag identification. The database 230 may store associations of tag 180 or tag identifications and their corresponding freight 120 or carrier 160. In some embodiments, the database 230 may provide the tag-freight/carrier association to the system 200 for further processing.

In some embodiments, the plurality of tag readers 170A, 170B, 170C, 170D (or collectively, 170 to include all tag readers alike) in the warehouse 100 may receive signals from the tags 180 (i.e., tag reads) wirelessly and transmit the tag reads to the system 200 (e.g., to any processor 210) for processing. In some embodiments, tag reads may refer to this tag 180 to tag reader 170 communication, which may be active or passive, as discussed above.

In some embodiments, the signal may include one or more report of its location and a corresponding time stamp. The one or more report of the tag location from the tag-tag reader communication is referred to as a raw location. In some embodiments, the tag reader 170 may read a tag 180, and calculate multiple locations from the raw locations using different preset algorithms on exact cadence. In some embodiments, the tag reader 170 may publish the reader-calculated locations to different processors according to preset rules. In some embodiments, this reader-calculated location is tag-specific, i.e., the reader-calculated location is a calculated location of the tag 180 and corresponds to single tag reader to tag communication. For example, the tag reader 170 may read a tag 180 and calculate two locations using two different preset algorithms, and publish the reader-calculated locations to different processors 210 for further processing. In some embodiments, the tag reader 170 may include a transitory memory 225 to temporary store tag reads, the raw locations, and the reader-calculated locations.

Similar to the tag reads of the multiple pieces of freight 120, in some embodiments, the plurality of tag readers 170 in the warehouse 100 may read the carrier tags 180 wirelessly and transmit the tag reads to the system 200 for processing. The tag reads may include one or more report of its location (i.e., raw location) and a corresponding time stamp. The tag reader 170 may similarly calculate multiple reader-calculated locations using different preset algorithms on exact cadence, and publish the reader-calculated locations to different processors according to preset rules.

In some embodiments, the tag reader 170 publishes all reader-calculated locations to the system 200 for processing. The system 200 receives, in the signal, all reader-calculated locations and indications of each of the reader-calculated locations and their corresponding algorithm (e.g., processing windows) and timestamp. Therefore, the system 200 may extract from one or more reader-calculated locations, their corresponding preset algorithm used, and their corresponding time, from one signal.

In some embodiments, the processor 210 may process the reader-calculated locations of the tag 180 and query the database 230 for association between the tag identification and the freight 120 or carrier 160, therefore associate the reader-calculated locations of the corresponding freight 120 or carrier 160 at the time of the time stamp. In some embodiments, the reader-calculated locations may use the same coordinate system as the warehouse. In some embodiments, each reader-calculated location may have tolerances. In some embodiments, the tolerances may be dictated by the tag reader's specification and use environment (e.g., temperature, humidity, or any other environmental conditions that may impact the data transmission between the tag and the tag reader.)

In some embodiments, the warehouse 100 may have at least one carrier 160 to move one or more freight 120 in the warehouse 100, i.e., change locations together with the freight 120. The carrier 160 may also load or unload freight 120, i.e., accept freight 120 into the warehouse 100, or transfer them out of the warehouse 100 (e.g., to truck 195A or airplane 195B). The carrier 160 may also arrange or rearrange freight 120 inside the warehouse 100, for example, from one storage bay 130 to another, or within a storage bay 130. In some embodiments, the warehouse 100 may have more than one carrier 160. Each carrier 160 may have a tag 180 associated with it. In some embodiments, tag for the carriers 160 may be the same as the tags used for the multiple pieces of freight. In some embodiments, tag for the carriers 160 may be different from the tags used for the multiple pieces of freight 120 in form but share a same frequency, so they may all be read, tracked and monitored by the same tag reader 170 in the system 200 at the same time. The database 230 may record the association of the tags for the carriers 160 and their corresponding carrier 160 and provide such association upon request.

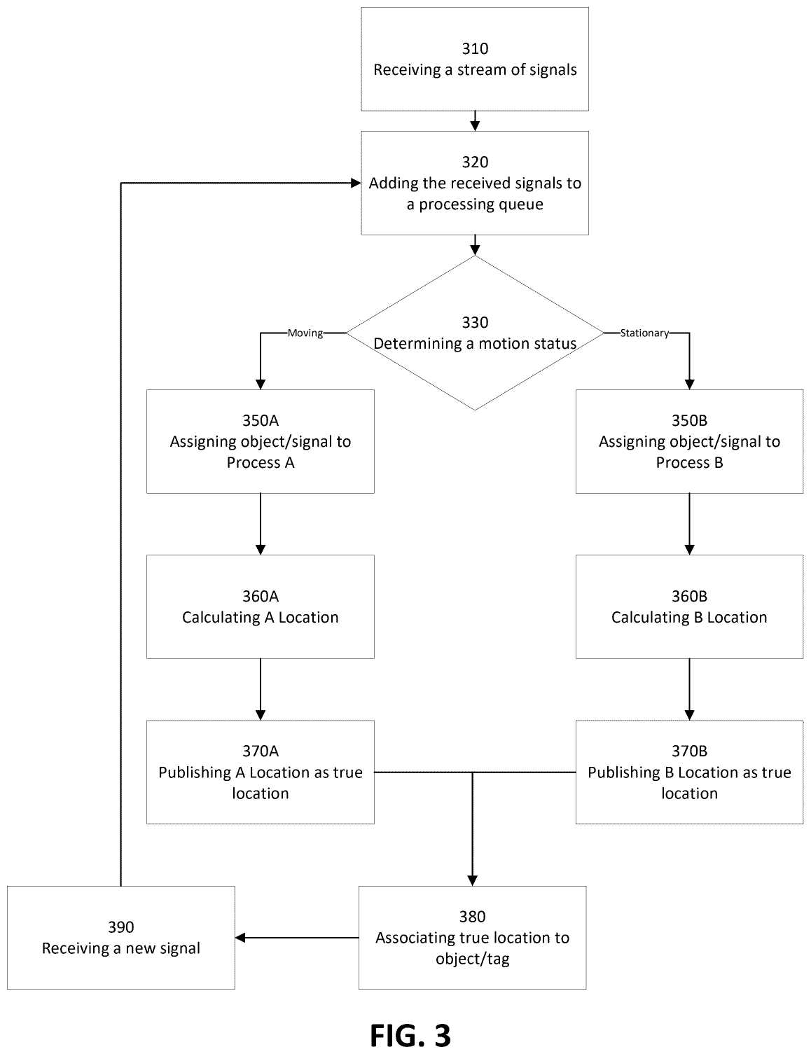

FIG. 3 is a schematic block diagram illustrating an embodiment of a method for tracking object locations, consistent with embodiments of this disclosure. In some embodiments, the process in FIG. 3 may be executed by one or more of processors 210.

In step 310, the processor 210 may receive a stream of signals of a tag 180 from a plurality of tag readers 170. In some embodiments, the processor 210 may periodically receive signals from the tag 180. In some embodiments, signals and tag reads may be used interchangeably, referring to the tag-tag reader communication (i.e., tag 180 to tag reader 170 communication). In some embodiments, the tag readers 170 may constantly monitor tags 180 in their covered areas (i.e., corresponding conical area 190).

In some embodiments, the stream of signals may comprise a plurality of signals in chronological order. Because each signal includes a timestamp, at least one of the processor 210 may arrange and record the stream of signals in chronological order according to their time stamps.

In some embodiments, each of the stream of signals may further comprise at least one reader-calculated (“raw”) locations from at least one tag reader. In some embodiments, the processor 210 may process the signals and query the database 230 for association between the tag identification and the freight 120 or carrier 160, therefore obtain the at least one reader-calculated location of the corresponding freight 120 or carrier 160 at the time of the time stamp. In some embodiments, the at least one reader-calculated location may be a coordinate with tolerances. In some embodiments, the tolerances may be broken down into tolerances along the coordinates (e.g., x-, y-, and z-coordinates). In some embodiments, the tolerances may be dictated by the tag reader's specification and use environment (e.g., temperature, humidity, or any other environmental conditions that may impact the data transmission between the tag and the tag reader).

In some embodiments, more than one tag reader 170 may read a same tag 180 at the same time and produce slightly different reader-calculated locations due to their perspective tolerances. In some embodiments, the each of the at least one tag reads may comprise a time stamp and at least one reader-calculated location. In some embodiments, when the time stamps of the multiple signals are very close to each other, the slightly different raw locations may appear to be the freight 120 or carrier 160 is jumping in locations while it is stationary or moving.

In step 320, the processor 210 may add the received signals to a processing queue for further processing. In some embodiments, the processing queue may be stored in a transitory memory 225. In some embodiments, the signals are time sensitive, i.e., signals that are older than a certain amount of time are irrelevant because the locations of the freight are more likely to have changed.

In step 330, the processor 210 may determine a motion status of the tag 180 and then assign the tag 180 to a first process or a second process. In some embodiments, the processor 210 may determine a motion status of the tag 180 and may consider the motion status of the tag 180 when assigning the tag 180 to the first or second process. In some embodiments, the motion status may include stationary and moving, which may further include moving speed and moving direction. In some embodiments, the moving speed may be a speed vector in the same coordinate that the warehouse 100 uses, and the moving direction may also be a vector in the same coordinate system.

In some embodiments, the processor 210 may determine the motion status by comparing a displacement between the reader-calculated locations using the short process window and the tag's last known location against a preset threshold. In this disclosure, the reader-calculated location using the short process window may be referred to as a Type I Location. If the tag 180 movement is more than the preset threshold, the processor 210 may consider the tag 180 having a moving motion status. In some embodiments, the preset threshold is dictated at least in part by the specification of the tag reader 170. In some embodiments, the preset threshold is dictated at least in part by the carrier 160 turning radius. For example, a carrier 160 may take a freight 120, back up, turn around and put it back to a different level in height. The preset threshold is set to not consider this level of movement as moving when determining the motion status.

In some embodiments, the processor 210 in some circumstances may not be able to determine the motion status of a tag 180. The processor 210 may then default the tag 180 to have a moving status.

In step 350A and 350B, In some embodiments, processors 210 may use a short computing window to calculate an A location in a first process (Process A), and use a long computing window to calculate a B location in a second process (Process B). In some embodiments, a short computing window may cover a time span of about 1-5 seconds, about 0.5-10 seconds, less than 5 seconds, or less than 10 seconds; a long computing window is relatively longer than the short computing window, and may cover a time span of about 5-15 seconds, about 3-20 seconds, about 3-30 seconds, or about 5-60 seconds. In some embodiments, the long computing window may be 3-10 times longer than the short computing window.

In some embodiments, the short process window of the tag reader may or may not be the same length of the short computing window of the system 200. Similarly, the long process window of the tag reader may or may not be the same length of the long computing window of the system 200. However, in general, the short process window is shorter than the long process window; the short computing window is shorter than the long computing window.

In step 350A, in some embodiments, in response to the tag 180 having a moving status, the processor 210 may assign the tag 180 to a first process (Process A). When a tag 180 is assigned to Process A, the processor 210 may prioritize the Type I Location in calculating and publishing Location A in Process A. That is, when the processor 210 determine that a tag 180 has a moving motion status, the processor 210 prefer (i.e., select and use) Type I Locations and short computing window in the following process steps.

In step 350B, in some embodiments, in response to the tag 180 having a stationary status, the processor 210 may assign the tag 180 to the second process (Process B). When a tag 180 is assigned to Process B, the processor 210 may prioritize the reader-calculated location using the long process window in calculating and publishing Location B in Process B. That is, when the processor 210 determine that a tag 180 has a stationary motion status, the processor 210 prefer (i.e., select and use) Type II Location in the following process steps. In this disclosure, the reader-calculated location using the long process window may be referred to as a Type II Location.

In some embodiments, the processor 210 may institute a wait period before prioritizing the Type II Location and publishing Location B. During this wait period, processor 210 monitors the Type I Location and compares it to Location B. If the Type I Location indicates that the object has acquired a moving motion status during the wait period, the processor 210 may stop implementing Process B and reassigning the object to Process A.

In some embodiments, the processor 210 may actively alert the system 200 and its user of the locations of tag 180 only when they have a moving status. In some embodiments, actively alerting the system 200 means that the processor 210 actively sends to the system 200 a location update (or a general status update) without the system 200 requesting it. In some embodiments, such alert may be in the form of visual or audio notification, blinking or change of color on a visual representation (e.g., a monitor or screen).

In some embodiments, locations of tag 180 with a stationary status would only be available upon inquiry. In some embodiments, this may mean that these tags 180 are not highlighted, or even not displayed (i.e., hidden) on a visual representation (e.g., a monitor or screen.) In some embodiments, processor 210 may always publish the locations of tag 180 with a stationary status to a separate outgoing data stream for data mining and to allow users to search for the location of freight 120 throughout the system. For example, processor 210 may always publish the locations of tag 180 with a stationary status to a separate subsystem (not pictured); a user may then query (e.g., using a user device, e.g., a computer, a smart phone, a handhold device, etc.) that subsystem to request the location of freight 120 associated with tag 180, (e.g., which warehouse the freight 120 is in, where the freight 120 is within the warehouse, etc.).

In some embodiments, the processor 210 may consider moving speed and moving directions when making such assignments. For example, a freight 120 has only a movement in height (i.e., z-axis) may be considered stationary, because such movement may indicate the freight is being re-arranged in the same storage bay 130. For example, a freight 120 making a 90-degree turn while not moving horizontally (i.e., stationary on x-axis and y-axis) may be considered moving, because such movement may indicate that the freight 120 is being loaded on a carrier 160 and ready to move.

In some embodiments, in response to the assignment of the tag 180 to Process A or Process B, the processor 210 may further calculate and publish the A location or the B location as a last known location (i.e., “true” location) and associate this true location to the corresponding tag 180 that produced the signal, hence associating the true location to the corresponding object.

In step 360A, in some embodiments, processor 210 may use Process A to calculate the A location from the stream of signals from the at least one tag reader 170. In some embodiments, processor 210 may calculate the A location by calculating a weighted average of the Type I Locations from the at least one tag reader 170.

In some embodiments, the signals and their corresponding Type I Locations may be given different weights when calculating the A location. For example, a more recent signal may be given a larger weight than an older signal; a signal from a tag reader that is closer to the object may be given a larger weight than a signal from another tag reader that is further from the object; a signal from a tag reader that has a stronger signal strength may be given a larger weight than a signal from another tag reader that has a weaker signal strength.

In some embodiments, calculating the A location may comprise generating a probability map using the Type I Locations and their corresponding confidence values. A probability map (also known as a probability density map or probability distribution map) shows the likelihood or probability of an object's actual location being at a specific location. In some embodiments, the probability map may be a graphical representation or a list of locations with their corresponding probability. In some embodiments, each of the at least one signal from the at least one reader may comprise a reader-calculated location and a corresponding confidence value. In some embodiments, processor 210 may calculate the confidence value from a signal. In some embodiments, for the purposes of calculating confidence values, processor 210 may compare the reader-calculated location to a last known location and the status of the tag 180 (i.e., stationary or moving, moving speed, moving directions, origin location, destination, environment temperature and humidity, and any other factor that may impact the tag reader's performance.) processor 210 may generate a probability map of the A location of the tag 180 using the at least one signal from the at least one tag reader 170 and their corresponding calculated confidence value. In some embodiments, the confidence values may be updated when new data (e.g., signals) becomes available.

In some embodiments, the processor 210 may use Process A to calculate A location in a short computing window. This is because when a tag 180 is moving, its historical locations are less relevant in determining its present location. Therefore, when calculating the A location, processor 210 may assign heavier weights to the signals and their corresponding Type I Location that are more recent. In some embodiments, the weights assigned to older reader-calculated locations may diminish relatively fast, compared to the weights assigned in Process B algorithms calculating the B location. In some embodiments, Process A may assign zero weight to all Type I Location that is not the latest. In other words, Process A may only calculate A location from the latest Type I Location.

In step 370A, in some embodiments, after A location is calculated, processor 210 may publish the A location as tag 180's true location. In some embodiments, processor 210 may further calculate speed of tag 180 using the A location and the last known location.

In step 360B, in some embodiments, processor 210 may use Process B to calculate the B location from the stream of signals from the at least one tag reader 170. In general, Process B may typically have a longer computing window, with longer time intervals between signals being processed.

In some embodiments, processor 210 may calculate the B location by calculating a weighted average of the Type II Location of the signals from the at least one tag reader 170. In some embodiments, the signals and their corresponding Type II Locations may be given different weights when calculating the B location. For example, a more recent signal may be given a larger weight than an older signal; a signal from a tag reader that is closer to the object may be given a larger weight than a signal from another tag reader that is further from the object; a signal from a tag reader that has a stronger signal strength may be given a larger weight than a signal from another tag reader that has a weaker signal strength.

In some embodiments, calculating the B location may comprise generating a probability map using the Type II Locations and their corresponding confidence values. In some embodiments, each of the at least one signal from the at least one tag reader 170 may comprise a Type II Location and a corresponding confidence value. In some embodiments, processor 210 may calculate the confidence value from a signal. In some embodiments, for the purposes of calculating confidence values, processor 210 may compare the Type II Locations to a last known location and the status of the tag 180 (i.e., stationary or moving, moving speed, moving directions, origin location, destination, environment temperature and humidity, and any other factor that may impact the tag reader's performance.) Processor 210 may generate a probability map of the B location of the tag 180 using the at least one signal from the at least one tag reader 170 and their corresponding calculated confidence value. In some embodiments, the confidence values may be updated when new data (e.g., signals) becomes available.

In step 370B, in some embodiments, processor 210 may use Process B to calculate and publish B location in a long computing window. This is because when a tag 180 is stationary, it is beneficial to use data spreading from a longer time span to average out errors from individual measurements. A stationary tag 180 may also tolerate larger time intervals of tag reads without missing much information of their location. Therefore, when calculating the B location, processor 210 may assign weights more evenly to the Type II Locations. In some embodiments, the more recent Type II Locations may still be assigned a heavier weight but may be less skewed towards the recent Type II Locations, compared to the weights assigned in Process A algorithms calculating the A location.

In some embodiments, in step 380, the processor 210 may associate the true location of tag 180, regardless it be published in Process A or Process B, to tag 180 and hence the object associated with the tag 180.

In some embodiments, in step 390, the processor 210 may receive a new signal of the tag 180. In some embodiments, like the other signals in the stream of signals, the new signal may also include reader-calculated locations (e.g., Type I Locations and Type II Locations) and a time stamp. In some embodiments, the processor 210 may then compare the Type I Location of this new signal against the A location or B location, depending on which corresponding process (i.e., Process A or Process B) the tag 180 is assigned to.

In some embodiments, the processor 210 may determine a moving speed of the tag 180 from the Type I Location and the time stamp of the new signal by comparing them to the last known location and time. In some embodiments, the processor 210 may compare the calculated moving speed of the tag 180 to a maximum speed. In some embodiments, the maximum speed may be determined from the carrier specification. For example, a forklift may only travel for up to a certain speed as a maximum speed. In some embodiments, the calculated moving speed being higher than the maximum speed of the carrier 160 is an indication that the signal has a larger than usual error. Therefore, in some embodiments, in response to the moving speed exceeds the maximum speed, the processor 210 may consider the new signal suspicious and assign a low weighting factor to it. In some embodiments, such new signal may be assigned a zero weight factor, i.e., be discarded or not used in the calculation in step 360A.

In some embodiments, the processor 210 may consider moving speed and moving directions when making such determinations. For example, a freight 120 has only a movement in height (i.e., z-axis) may be considered stationary, because such movement may indicate the freight 120 is being re-arranged in the same storage bay 130. For example, a freight 120 making a 90-degree turn while not moving horizontally (i.e., stationary on x-axis and y-axis) may be considered moving, because such movement may indicate that the freight 120 is being loaded on a carrier 160 and ready to move. It is recognized, however, such considerations may be integrated into the preset threshold. Setting the preset threshold may require trial and error, in lieu of the considerations of tag reader specifications and other factors, as discussed above.

In some embodiments, when the moving tag 180 is outside of all the conical areas 190 of the tag readers 170, processor 210 may miss receiving the new signal when it is scheduled to be received and thus lost track of the moving tag 180. In some embodiments, processor 210 may predict an A location using the stream of signals and the calculated moving speed and moving directions. Because the tag 180 is moving, the A location may be calculated in Process A, and the processor 210 may assign the calculated third location as the latest true location (a latest A location). In some embodiments, the calculated A location may be assigned a lower weight when used in future calculations. In some embodiments, the calculated A location may be verified or corrected by one or more subsequent signals when the tag 180 moves back inside the conical areas 190 of at least one tag readers 170. In some embodiments, the weight of the calculated A location may be adjusted back to a normal value (i.e., as if the A location was not a predicted one but an actual one) after verification and/or correction.

In some embodiments, from the result of the comparison, similar to steps 330, 350A, and 350B, the processor 210 may determine whether the assignment (i.e., Process A or Process B) requires an update or change, i.e., the processor 210 may compare a displacement between the new signal's Type I Location and the tag's last known location against the preset threshold. If the tag 180 movement is more than the preset threshold, the processor 210 may consider the tag 180 having a moving motion status and assign the tag 180 to Process A; if the tag 180 movement is less than the preset threshold, the processor 210 may consider the tag 180 having a stationary motion status and assign the tag 180 to Process B. In case the processor 210 cannot determine the motion status of a tag 180, the processor 210 may then default the tag 180 to have a moving status and assign the tag 180 to Process A.

In some embodiments, the processor 210 may add the new signal to the stream of signals and ready for receiving the next new signal, and repeat steps 310-380. In some embodiments, this process may repeat until the tag 180 is removed from the system 200, for example, when the tag 180 and its corresponding freight 120 are loaded to a transportation vehicle (e.g., truck 195A or flight 195B) and leave the warehouse 100. In some embodiments, the system 200 may notify other systems about the final disposal of the tag 180 and its corresponding freight 120 so the other systems may take over the tracking information.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, HTML with included Java applets, or Golang.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for tracking an object, comprising:
at least one processor;
at least one non-transitory memory storing instructions, when executed by the at least one processor, perform steps of:
receiving, from a plurality of tag readers, a stream of signals of an object, the stream of signals comprises a plurality of signals in chronological order;
wherein each signal within the stream of signals comprises a first raw location, a second raw location, and a timestamp;
determining a first motion status of the object using the first raw location;
assigning the object to a first process or a second process based on the first motion status;
in response to the assignment to the first process:
calculating a first location using the first raw locations of the stream of signals in a first process; and
publishing the first location as a true location;
in response to the assignment to the second process:
calculating a second location using the second raw locations of the stream of signals in a second process; and
publishing the second location as a true location; and
associating the true location to the object.

2. The system of claim 1, the steps further comprising:
receiving a new signal of the object, the new signal comprises a first raw location, a second raw location, and a timestamp;
adding the new signal to the stream of signals;
determining, using the first raw location of the new signal and the true location, a second motion status of the object;
assigning the object to the first process or the second process based on the second motion status;
in response to the assignment to the first process:
updating the first location using the first raw location of the new signal in the first process; and
publishing the updated first location as the updated true location;
in response to the assignment to the second process:
updating the second location using the second raw location of the new signal in the second process; and
publishing the updated second location as the updated true location; and
associating the updated true location to the object.

3. The system of claim 2, wherein each of the plurality of tag readers provides one signal of the stream of signals and covers a conical area, each reader being at a vertex of the conical area.

4. The system of claim 3, the steps further comprising:
predicting an updated first location based on determining that the first raw location of the new signal is outside of all the conical areas of the plurality of tag readers.

5. The system of claim 2, the steps further comprising:
determining a moving speed of the object from the updated first location and the corresponding timestamp of the new signal;
comparing the moving speed of the object to a maximum speed; and
in response to the moving speed exceeds the maximum speed, discarding the new signal.

6. The system of claim 1, wherein the first motion status is moving or stationary, and wherein determining the first motion status comprises:
in response to the object having the moving motion status, assigning the object to the first process; and
in response to the object having the stationary motion status, assigning the object to the second process.

7. The system of claim 1, wherein:
calculating the first location uses the first raw locations of the stream of signals in a first computing window;
calculating the second location uses the second raw locations of the stream of signals in a second computing window; and
the first computing window is shorter than the second computing window.

8. The system of claim 1, wherein each of the first raw locations of the stream of signals and the second raw locations of the stream of signals has a corresponding confidence value.

9. The system of claim 8, wherein calculating the first location comprises generating a probability map using the first raw locations of the stream of signals and their corresponding confidence values.

10. The system of claim 8, wherein calculating the second location comprises generating a probability map using the second raw locations of the stream of signals and their corresponding confidence values.

11. The system of claim 1, wherein the first location is determined by calculating a weighted average of the first raw locations of the signals from the plurality of tag readers.

12. The system of claim 1, wherein the second location is determined by calculating a weighted average of the second raw locations of the stream of signals from the plurality of tag readers.

13. A method for tracking an object, comprising:
receiving, from a plurality of tag readers, a stream of signals of an object, the stream of signals comprises a plurality of signals in chronological order;
wherein each signal within the stream of signals comprises a first raw location, a second raw location, and a timestamp;
determining a first motion status of the object using the first raw location;
assigning the object to a first process or a second process based on the first motion status;
in response to the assignment to the first process:
calculating a first location using the first raw locations of the stream of signals in a first process; and
publishing the first location as a true location;
in response to the assignment to the second process:
calculating a second location using the second raw locations of the stream of signals in a second process; and
publishing the second location as a true location; and
associating the true location to the object.

14. The method of claim 13, wherein assigning the object to the first process or the second process comprises:
receiving a new signal of the object, the new signal comprises a first raw location, a second raw location, and a timestamp;
adding the new signal to the stream of signals;
determining, using the first raw location of the new signal and the true location, a second motion status of the object;
assigning the object to the first process or the second process based on the second motion status;
in response to the assignment to the first process:
updating the first location using the first raw location of the new signal in the first process; and
publishing the updated first location as the updated true location;
in response to the assignment to the second process:
updating the second location using the second raw location of the new signal in the second process; and
publishing the updated second location as the updated true location; and
associating the updated true location to the object.

15. The method of claim 14, wherein each of the plurality of tag readers provides one signal of the stream of signals and covers a conical area, each reader being at a vertex of the conical area.

16. The method of claim 15, further comprising:
predicting an updated first location based on determining that the first raw location of the new signal is outside of all the conical areas of the plurality of tag readers.

17. The method of claim 14, further comprising:
determining a moving speed of the object from the updated first location and the corresponding timestamp of the new signal;
comparing the moving speed of the object to a maximum speed; and
in response to the moving speed exceeds the maximum speed, discarding the new signal.

18. The method of claim 13, wherein the first motion status is moving or stationary, and wherein determining the first motion status comprises:
in response to the object having the moving motion status, assigning the object to the first process; and
in response to the object having the stationary motion status, assigning the object to the second process.

19. The method of claim 13, wherein:
calculating the first location uses the first raw locations of the stream of signals in a first computing window;
calculating the second location uses the second raw locations of the stream of signals in a second computing window; and
the first computing window is shorter than the second computing window.

20. The method of claim 13, wherein each of the first raw locations of the stream of signals and the second raw locations of the stream of signals has a corresponding confidence value.

21. The method of claim 20, wherein calculating the first location comprises generating a probability map using the first raw locations of the stream of signals and their corresponding confidence values.

22. The method of claim 20, wherein calculating the second location comprises generating a probability map using the second raw locations of the stream of signals and their corresponding confidence values.

23. The method of claim 13, wherein the first location is determined by calculating a weighted average of the first raw locations of the stream of signals from the plurality of tag readers.

24. The method of claim 13, wherein the second location is determined by calculating a weighted average of the second raw locations of the stream of signals from the plurality of tag readers.
